(19) United States
(12) Patent Application Publication
(10) Pub. No.: US 2009/0245443 A1
(43) Pub. Date: Oct. 1, 2009

(54) DIVERSITY RECEIVER

(75) Inventors: Kazuo TAKAYAMA, Hyogo (JP); Hidenori GOHHARA, Hyogo (JP); Takumi YOSHIMOTO, Hyogo (JP); Katsushi SANDA, Aichi (JP); Nobuo ITOH, Aichi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-shi (JP)

(21) Appl. No.: 12/414,061

(22) Filed: Mar. 30, 2009

(30) Foreign Application Priority Data
Mar. 29, 2008 (JP) 2008-088914

(51) Int. Cl. H04B 7/10

(52) U.S. Cl. 375/347

(57) ABSTRACT

A diversity receiver is provided. A first adaptive array unit includes a first combiner that obtains a first combined signal comprised mainly of a first wave of received signals by combining received signals of a plurality of antennas with using first complex weights. A second adaptive array unit includes a first component subtractor that subtract the first combined signal from the respective received signals and a second combiner that obtains a second combined signal comprised mainly of a second wave of the received signals by combining the received signals and outputs of the first component subtractor with using second complex weights. The first combiner includes a delay wave suppressing unit that generates a suppressed signal in which components of the second wave is suppressed from the first combined signal and a first weight coefficient operating unit that determines the first complex weights by complex correlation operation between outputs of the delay wave suppressing unit and the received signals. The second combiner includes a second weight coefficient operating unit that determines the second complex weights by complex correlation operation between the second combined signal and the outputs of the first component subtractor.

Priority is claimed to Japanese Patent Application No. 2008-088914 filed on Mar. 29, 2008, the disclosure of which, including the specification, drawings and claims, is incorporated herein by reference in its entirety.

### BACKGROUND

The present invention relates to a diversity receiver in a state where a desired wave such as a direct wave, and an interference wave such as a delay wave exist. The present invention can be applied to a receiver for receiving the terrestrial digital television broadcasting broadcasted by an OFDM (Orthogonal Frequency-Division Multiplexing) method in a mobile object such as a vehicle.

Japanese Patent No. 3696013 discloses a related-art diversity receiver for multi-carrier communication that determines complex weights by complex correlation coefficients of a combined wave and a received wave of each antenna. Japanese Patent No. 4066759 (Japanese Patent Publication No. 2004-120334 A) discloses a related art that performs diversity synthesis in a frequency domain by separating the desired wave such as a direct wave from the delay wave by two adaptive arrays.

In the related art disclosed in Japanese Patent No. 4066759, a first adaptive array acquires a first signal consisting mainly of components of the desired wave by using a power difference between the desired wave such as the direct wave and the delay wave. At this time, the same information as the desired wave such as the direct wave except that the delay wave is delayed can be acquired from the delay wave. Therefore, by combining signals in which the components of the first signal is respectively subtracted from received signals of antennas in a second adaptive array, a second signal consisting mainly of the delay wave having the strongest power is acquired. Thus, the first signal consisting mainly of the components of the desired wave and the second signal consisting mainly of the delay wave having the strongest power are separated into subcarriers by FFT (Fast Fourier Transform). Then, high gain diversity is realized. This is a path diversity based on the fact that the first signal consisting of the components of the desired wave and the second signal consisting of the delay signal having the strongest power are transmitted through different paths.

A related-art diversity receiver will be explained with reference to the drawings. FIG. 9 is a block diagram illustrating a configuration of a related-art diversity receiver 900. The diversity receiver 900 of the FIG. 9 acquires signals of each subcarrier from respective received waves modulated by the OFDM method.

The diversity receiver 900 of FIG. 9 consists of four antennas A1, A2, A3 and A4, four tuners 11, 12, 13, and 14, an orthogonal demodulation unit 20, two complex correlation operation and weight synthesis units 90 and 50, a first component subtractor 40, two Fast Fourier Transform processors 61 and 62, and a combiner 70.

Here, transmissions of complex baseband signals are shown by double-lined arrows in intervals from the orthogonal demodulation unit 20 to the Fast Fourier Transform processors 61 and 62.

Also, to show the essential point, buffer memories are omitted in FIG. 9. However, as will be understood, the function of the buffer memory is provided at positions where the function is needed. Window processing for eliminating guard band is performed in the Fast Fourier Transform processors 61 and 62. Also, to implement the operation of the related-art diversity receiver, signals to be transmitted through different paths and to be combined in the receiver are always synchronized at each symbol section.

Also, to implement the operation of the related-art diversity receiver, baseband signals Y1 and Y2 are automatically adjusted to a predetermined power after generation by adding.

The operations of the diversity receiver 900 in FIG. 9 are as follows. The four antennas A1, A2, A3 and A4 are disposed at predetermined positions, respectively. The tuners 11, 12, 13 and 14 convert received signals received by the antennas A1, A2, A3 and A4 into the Intermediate Frequency (IF) signals, respectively. A tuner includes typical functions such as a function of mixer, a function of AGC (Automatic Gain Control), and a function of A/D conversion, etc. The Intermediate Frequency (IF) signals are respectively demodulated into four complex baseband signals X11, X12, X13 and X14 which are digital signals composed of I components and Q components respectively by the orthogonal demodulation unit 20. The A/D conversion can be performed either before the orthogonal demodulation or after the orthogonal demodulation. The baseband signals X11, X12, X13 and X14 are output to the complex correlation operation and weight combiner 90 and the first component subtractor 40.

A complex correlation operation and weight combiner 90 weights the complex baseband signals X11, X12, X13 and X14 with the complex weights W11, W12, W13 and W14 and synthesizes them to obtain a combined signal Y1. After this, the combined signal Yl is fed back to obtain four mutual correlations (complex numbers) based on correlation operation with the combined signal Y1 and four complex baseband signals X11, X12, X13 and X14. The complex weights W11, W12, W13 and W14 are updated based on the obtained four mutual correlations. In such a manner, the complex correlation operation and weight combiner 90 performs the feedback control such that the contribution of a first wave S1 which is a direct wave or a received wave in the fastest arriving path to the combined signal Y1 is increased based on the complex baseband signals X11, X12, X13 and X14.

On the other hand, the complex correlation operation and weight combiner 90 outputs the combined signal Y1 and the conjugate complex numbers W11*, W12*, W13* and W14* of the complex weights W11, W12, W13, and W14 to the first component subtractor 40. The first component subtractor 40 subtracts values obtained by multiplying the combined signal Y1 by the conjugate complex numbers W11*, W12*, W13*, and W14* respectively from four complex baseband signals X11, X12, X13, and X14, and then obtains four baseband signals X21, X22, X23, and X24 in which the contribution of the first wave S1 became small. The baseband signals X21, X22, X23 and X24 are output to the complex correlation operation and weight combiner 50. A combined signal Y2 is obtained by the same process as that of the complex correlation operation and weight combiner 90. The complex correlation operation and weight combiner 50 performs the feedback control such that the contribution of the second wave S2 which is a received wave arrived next to the first wave S1 to the combined signal Y2 is increased.

The obtained combined signal Y1 which has large contribution of the first wave S1 is input to the Fast Fourier Transform processor 61, and the combined signal Y2 which has large contribution of the second wave S2 is input to the Fast Fourier Transform processor 62 so that signals of each subcarrier are respectively obtained. The combiner 70 combines obtained signals in each subcarrier. At this time, selection may be performed instead of the combining. In other words, the path diversity can performed by the signal per each subcarrier obtained from the combined signal Y1 in which components of the other interference wave is reduced by an adaptive array with respect to the first wave S1, and the signal per each subcarrier obtained from the combined signal Y2 in which components of other interference wave is reduced by the adaptive array with respect to the second wave S2.

FIG. 10 is a block diagram illustrating a configuration from the orthogonal demodulation unit 20 to two Fast Fourier Transform processors 61 and 62 in detail. The detailed configurations of the complex correlation operation and weight combiner 90, the first component subtractor 40, and a complex correlation operation and weight combiner 50 are as follows.

The complex correlation operation and weight combiner 90 consists of four complex multipliers 91, 92, 93 and 94, a weight coefficient operating unit 95 and an adder 96.

Four complex baseband signals X11, X12, X13 and X14 output from the orthogonal demodulation unit 20 are output to four multipliers 91, 92, 93 and 94, and a weight coefficient operating unit 95. Four complex weights W11, W12, W13 and W14 from the weight coefficient operating unit 95 are output to four multipliers 91, 92, 93 and 94. The complex multiplied values W1iX1i are respectively output from four complex multipliers 9i to an adder 96 (where i is a natural number not larger than 4). The adder 96 outputs a combined signal Y1 by mutually adding the four complex multiplied values W1iX1i (where i is a natural number not larger than 4).

The combined signal Y1 is adjusted to a predetermined power after calculated by ΣW1iX1i. The combined signal Y1 which is the output of the adder 96 is output to the Fast Fourier Transform processor 61, the weight coefficient operating unit 95, and the first component subtractor 40.

The weight coefficient operating unit 95 obtains four mutual correlations (complex numbers) by the mutual correlation with the combined signal Y1 and four complex baseband signals X11, X12, X13, and X14, and updates complex weights W11, W12, W13 and W14, based on the four mutual correlations. The conjugate complex numbers W11*, W12*, W13* and W14* of the complex weights W11, W12, W13 and W14 are output to the first component subtractor 40.

The first component subtractor 40 consists of four complex multipliers 41, 42, 43 and 44, and four adders (subtractors) 46, 47, 48 and 49.

Four complex multipliers 41, 42, 43 and 44 respectively multiply the respective conjugate complex numbers W11*, W12*, W13* and W14* which are the output of the weight coefficient operating unit 95 by the combined signal Y1 which are the output of the adder 96 to obtain values W11*Y1, W12*Y1, W13*Y1, W14*Y1 and output the obtained values to four adders (subtractors) 46, 47, 48 and 49.

The adders (subtractors) 46, 47, 48 and 49 subtract the multiplied values W11*Y1, W12*Y1, W13*Y1 and W14*Y1 output from four complex multipliers 41, 42, 43 and 44 respectively from the four complex baseband signals X11, X12, X13 and X14 output from the orthogonal demodulation unit 20, and output four new signals X2i=X1i−W1i*Y1 (where i is a natural number not larger than 4) to the complex correlation operation and weight combiner 50.

The complex correlation operation and weight combiner 50 consists of four complex multipliers 51, 52, 53 and 54, a weight coefficient operating unit 55, and an adder 56. That is, the complex correlation operation and weight combiner 50 consists of the same components as those of the complex correlation operation and weight combiner 90. Such as the complex correlation operation and weight combiner 90 outputs a combined signal Y1 based on the four complex baseband signals X11, X12, X13 and X14, the complex correlation operation and weight combiner 50 outputs a combined signal Y2 based on the four complex baseband signals X21, X22, X23 and X24.

The combined signal Y2 is adjusted to a predetermined power after calculated by ΣW2ix2i. In such a manner, the combined signal Y2 became the same power as the power of the combined signal Y1.

When the complex correlation operation and weight combiner 90 obtains the combined signal Y1 from the four complex baseband signals X11, X12, X13 and X14, the feedback control is performed to increase the contribution of the first wave S1 which is the direct wave or the received wave in the fastest arriving path to the combined signal Y1. On the other hand, when the complex correlation operation and weight combiner 50 obtains the combined signal Y2 from the four complex baseband signals X21, X22, X23 and X24, because the contribution of the first wave S1 to the four complex baseband signals X21, X22, X23 and X24 becomes a little or disappears, the feedback control is performed to increase the contribution of the second wave S2 which is a received wave arrived next to the first wave S1 to the combined signal Y2.

The related-art diversity receiver 900 utilizes the power difference between the desired wave such as the direct wave and the delay wave. That is, the complex correlation operation and weight combiners 90 and 50 are the adaptive arrays which performs the feedback control to increase the contribution degree of the received wave S1 or S2 having the highest contribution degree to the combined signal Y1 or Y2. Accordingly, when the power difference between the desired wave such as the direct wave and the delay wave is a little or does not exist, the related-art diversity receiver 900 does not work. Actually, it is verified in a simulation of the related-art diversity receiver 900 that the direct wave is not separated from the delay wave in the first combined signal Y1 and the second combined signal Y2 in a case where the direct wave and the delay wave which have the same power are arrived at an angle of 30 degrees with respect to an antenna array in which four antennas are arranged in a straight line.

### SUMMARY

It is therefore an object of at least one embodiment of the present invention to provide a diversity receiver which is effective even in a case where the power difference between the desired wave such as the direct wave and the delay wave is a little or does not exist.

In order to achieve the above-described object, according to a first aspect of at least one embodiment of the present invention, there is provided a diversity receiver, comprising: a first adaptive array unit that obtains a first combined signal by combining received signals of a plurality of antennas with using first complex weights; and a second adaptive array unit that obtains a second combined signal by combining the received signals of the antennas with using second complex weights, wherein the first adaptive array unit includes a first combiner that obtains the first combined signal comprised mainly of a first wave of the received signals, wherein the second adaptive array unit includes a first component subtractor that subtract the first combined signal from the respective received signals and a second combiner that obtains the second combined signal comprised mainly of a second wave of the received signals based on outputs of the first component subtractor, wherein the first combiner includes a delay wave suppressing unit that generates a suppressed signal in which components of the second wave is suppressed from the first combined signal and a first weight coefficient operating unit that determines the first complex weights by complex correlation operation between outputs of the delay wave suppressing unit and the received signals, and wherein the second combiner includes a second weight coefficient operating unit that determines the second complex weights by complex correlation operation between the second combined signal and the outputs of the first component subtractor.

The delay wave suppressing unit may include: a plurality of delay circuits which are connected in serial, the delay circuits to which the first combined signal is input; a third weight coefficient operating unit that determines third complex weight by complex correlation operation between each of outputs of the delay circuits and the first combined signal; a plurality of multipliers that multiplies the outputs of the delay circuits by the third weight coefficient, respectively; and an adder-subtractor that subtracts outputs of the multipliers from the first combined signal to generate the suppressed signal.

The antennas may be divided into a plurality of groups, and the first and second adaptive array units may obtain the first and second combined signals in at least one of the groups. The received signals may be multi-carrier modulated signals, and the first combined signal and the second combined signal may be separated into subcarriers and then subjected to path diversity. The received signals may be OFDM (Orthogonal Frequency-Division Multiplexing) signals.

According to a second aspect of at least one embodiment of the present invention, there is provided a diversity receiver, comprising: an adaptive array unit that obtains a combined signal comprised mainly of a first wave of received signals of a plurality of antennas by combining the received signals with using first complex weights, wherein the adaptive array unit includes a delay wave suppressing unit that generates a suppressed signal in which components of a second wave of the received signals is suppressed from the combined signal and a first weight coefficient operating unit that determines the first complex weights by complex correlation operation between outputs of the delay wave suppressing unit and the received signals.

The delay wave suppressing unit may include: a plurality of delay circuits which are connected in serial, the delay circuits to which the combined signal is input; a second weight coefficient operating unit that determines second complex weight by complex correlation operation between each of outputs of the delay circuits and the combined signal; a plurality of multipliers that multiplies the outputs of the delay circuits by the second weight coefficient, respectively; and an adder-subtractor that subtracts outputs of the multipliers from the combined signal to generate the suppressed signal.

The received signals may be OFDM (Orthogonal Frequency-Division Multiplexing) signals.

Considering that the delay wave suppressing unit which suppresses the contribution degree of the second wave in the first combined signal is used in the first adaptive array unit in a case where no power difference between the first wave which is the direct wave or the received wave in the fastest arriving path and the second wave which is the received wave arrived next to the first wave exists, it is not desirable to replace the first combined signal by the output of the delay wave suppressing unit as a signal which must be demodulated at subsequent stage of the diversity receiver. On the contrary, as long as it is not necessary to demodulate the output at the subsequent stage of the diversity receiver, the output of the delay wave suppressing unit may have the possibility of increasing the distortion. That is, even if the complex correlation operation for calculating the complex weights to generate the first combined signal has the possibility of increasing the distortion, the complex correlation operation between a signal in which the contribution degree of the second wave is decreased and the received signals is performed. Once the first combined signal in which the contribution degree of the first wave is larger than the contribution degree of the second wave is generated, the degree of the first wave in the first combined signal comes close to 100% by repeating. the feedback control, and then the accuracy of the final demodulation is improved step by step.

When the first combined signal having low contribution degree of the second wave is obtained in the first adaptive array unit, the second combined signal having low contribution degree of the first wave can be obtained in the second adaptive array.

Such a delay wave suppressing unit can suppress the delay wave by inputting the first combined signal to a plurality of delay circuits which are connected in serial, performing the complex correlation operation between the output of each delay circuits which is different in a delay time and the first combined signal which is not delayed, and combining with using the complex weights.

Dividing the antennas into a plurality of groups, the above operation can be performed in at least one of the groups. In such a case, the residual groups in which the above operation is not performed can be configured to have the same configuration as that of the related-art diversity receiver 900.

The present invention can be effectively applied to the multi-carrier communication and the path diversity can be performed after separating into subcarriers. In addition, the present invention can be effectively applied to the terrestrial digital broadcasting using OFDM.

### BRIEF DESCRIPTION OF THE DRAWINGS

The above objects and advantages of the present invention will become more apparent by describing in detail exemplary embodiments thereof with reference to the accompanying drawings, wherein:

FIG. 1 is a block diagram illustrating a configuration of a diversity receiver according to an embodiment of the present invention;

FIG. 2 is a block diagram illustrating a detailed configuration of the diversity receiver according to the embodiment;

FIG. 3 is a block diagram illustrating a detailed configuration of a DUR improving unit in the diversity receiver according to the embodiment;

FIG. 4 is conceptual diagrams illustrating an operation of the DUR improving unit;

FIG. 5 is a plan view illustrating an arrangement of antennas and an arrival direction of the first wave and the second wave in a simulation;

FIG. 6 is graph diagrams showing the simulation results of the diversity receiver 100 and related-art diversity receiver 900;

FIG. 7 is a block diagram illustrating a configuration of a diversity receiver according to another embodiment of the present invention;

FIG. 8 is graph diagrams showing the simulation results of the diversity receiver 100 according to the embodiment, the diversity receiver 200 according to another embodiment, a related-art diversity receiver 900, a diversity receiver 950 according to a comparative example and a diversity receiver 990 according to another comparative example;

FIG. 9 is a block diagram illustrating a configuration of the related-art diversity receiver 900;

FIG. 10 is a block diagram illustrating a detailed configuration of the related-art diversity receiver 900;

FIG. 11 is a block diagram illustrating a configuration of the diversity receiver 950 according to a comparative example;

FIG. 12 is a block diagram illustrating a configuration of the diversity receiver 990 according to another comparative example; and

FIG. 13 is a block diagram illustrating a detailed configuration of the DUR improving unit 375 according to a modified example.

### DETAILED DESCRIPTION OF THE EMBODIMENTS

Hereinafter, embodiments of the present invention will be described with reference to the accompanying drawings.

### EXAMPLE 1

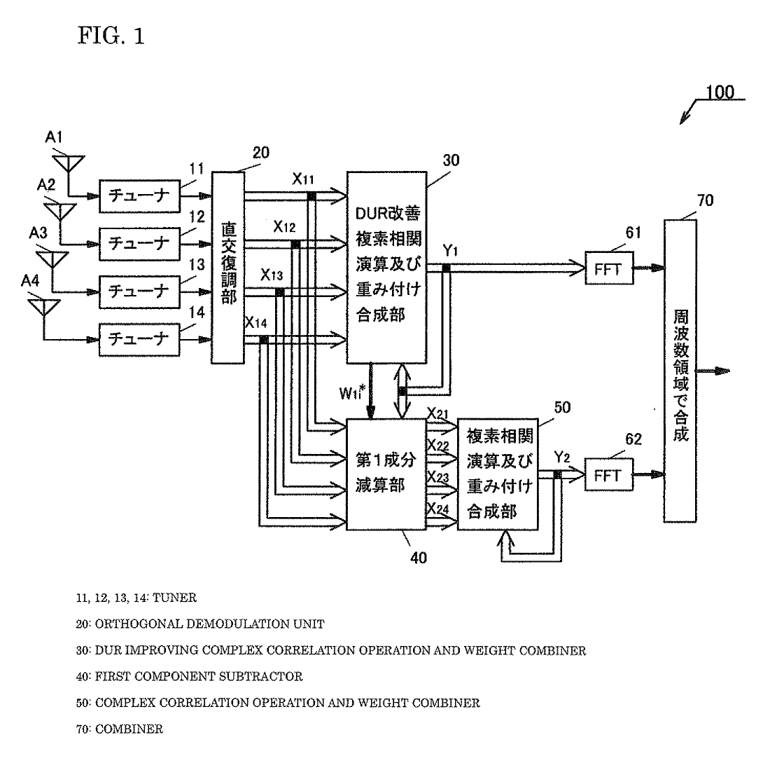

As shown in FIG. 1, a configuration of the diversity receiver 100 has the same as that of the related-art diversity receiver 900 except that a complex correlation operation and weight combiner 90 is replaced by a DUR (Desire Undesire Ratio) improving complex correlation operation and weight combiner 30.

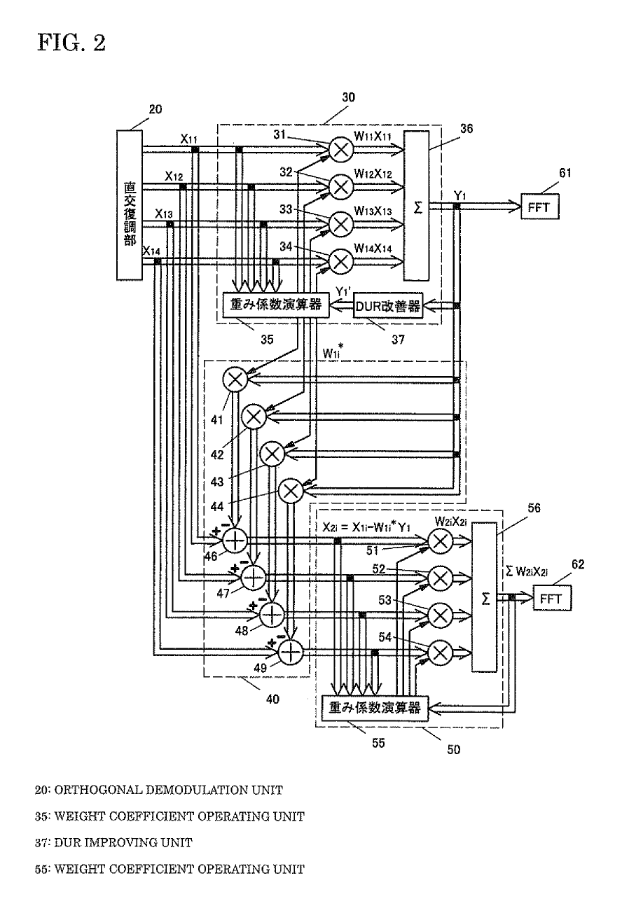

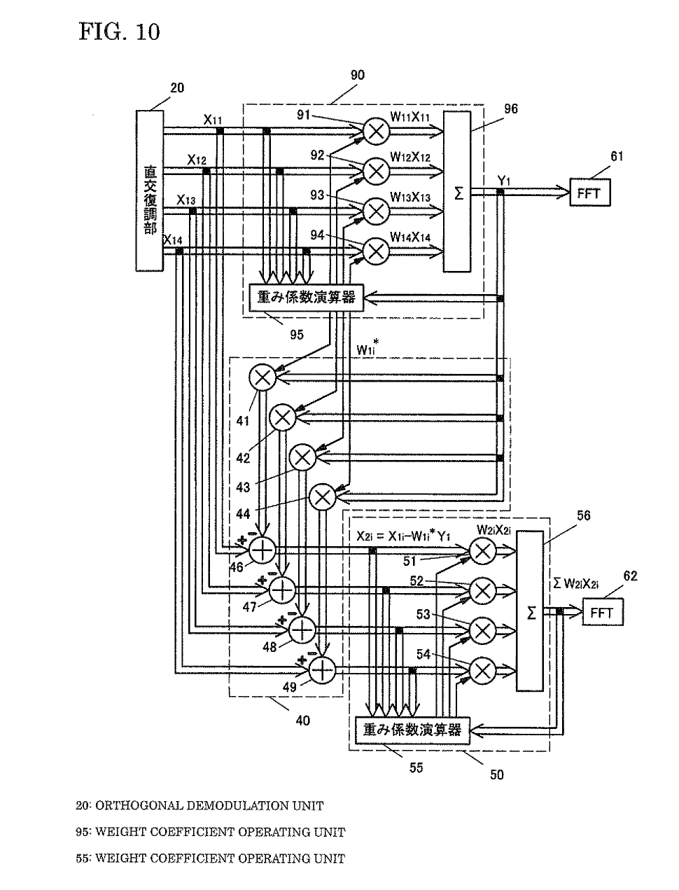

As shown in FIG. 2, the configuration of a first component subtractor 40, the configuration of a complex correlation operation and weight combiner 50 has the same as that of the first component subtractor 40, and that of the complex correlation operation and weight combiner 50 in FIG. 10.

The detailed configuration of the DUR improving complex correlation operation and weight combiner 30 is described as follows.

The DUR improving complex correlation operation and weight combiner 30 in FIG. 2 includes four complex multipliers 31, 32, 33, and 34, a weight coefficient operating unit 35, an adder 36, and a DUR improving unit 37.

While the output of the adder 96 of FIG. 10 is directly input to the weight coefficient operating unit 95, the combined signal Y1 which is the output of the adder 36 of FIG. 2 is converted into a signal Y1′ through the DUR improving unit 37 and input to the weight coefficient operating unit 35.

That is, when updating the complex weights, the DUR improving complex correlation operation and weight combiner 30 of FIG. 2 performs the complex correlation the baseband signals X11, X12, X13 and X14 with the signal Y1 instead of the combined signal Y1. In other words, the diversity receiver 100 of FIG. 2 performs the complex correlation between the baseband signals X11, X12, X13 and X14 with signal Y1′ in which the influence of the second wave is suppressed from the combined signal Y1 by the DUR improving unit 37 instead of the combined signal Y1 when obtaining the combined signal Y1 having high contribution degree of the first wave which is the desired wave.

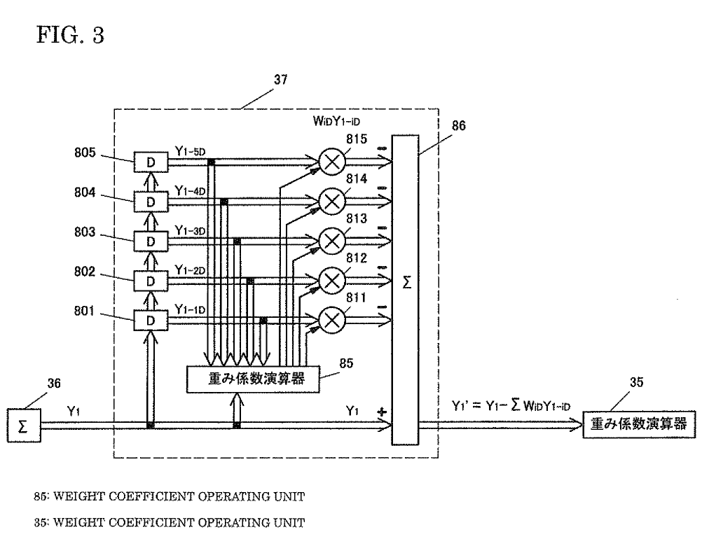

As shown in FIG. 3, the DUR improving unit 37 includes five delay circuits (memories) 801, 802, 803, 804, and 805, five complex multipliers 811, 812, 813, 814 and 815, a weight coefficient operating unit 85 and an adder-subtractor 86.

The combined signal Y1 which is the output of the adder 36 is output to the delay circuit (memory) 801, the weight coefficient operating unit 85, and an adder-subtractor 86.

The combined signal Y1 which is input to the delay circuit (memory) 801 is delayed by a delay time tD to become delayed signal Y1-1D, and the delayed signal Y1-1D is output to the delay circuit (memory) 802, the complex multipliers 811, and the weight coefficient operating unit 85.

The signal Y1-1D input to the delay circuit (memory) 802, is further delayed by the delay time tD to become delayed signal Y1-2D, and the delayed signal Y1-2D is output to the delay circuit (memory) 803, the complex multipliers 812, and the weight coefficient operating unit 85.

The signal Y1-2D input to the delay circuit (memory) 803, is further delayed by the delay time tD to become delayed signal Y1-3D, and the delayed signal Y1-3D is output to the delay circuit (memory) 804, the complex multipliers 813, and the weight coefficient operating unit 85.

The signal Y1-3D input to the delay circuit (memory) 804, is further delayed by the delay time tD to become delayed signal Y1-4D, and the delayed signal Y1-4D is output to the delay circuit (memory) 805, the complex multipliers 814, and the weight coefficient operating unit 85.

The signal Y1-4D input to the delay circuit (memory) 805, is further delayed by the delay time tD to become delayed signal Y1-5D, and the delayed signal Y1-5D is output to the complex multipliers 815, and the weight coefficient operating unit 85.

Five complex weights W1D, W2D, W3D, W4D and W5D are output from the weight coefficient operating unit 85 to five complex multipliers 811, 812, 813, 814, and 815 respectively.

The five complex multipliers 811, 812, 813, 814, and 815 output multiplied values W1DY1-1D, W2DY1-2D, W3DY1-3D, W4DY1-4D, and W5DY1-5D to the adder-subtractor 86.

The adder-subtractor 86 subtracts the multiplied values W1DY1-1D, W2DY1-2D, W3DY1-3D, W4DY1-4D, and W5DY1-5D respectively from the combined signal Y1 which is the output of the adder 36, then generates a converted signal Y1′, and outputs the converted signal Y1′ to the weight coefficient operating unit 35.

Also, the weight coefficient operating unit 85 determines the five complex weights W1D, W2D, W3D, W4D and W5D by the complex correlation between the combined signal Y1 which is the output of the adder 36 and each of the delayed signals Y1-1D, Y1-2D, Y1-3D, Y1-4D and Y1-5D. The absolute values of the five complex weights W1D, W2D, W3D, W4D and W5D, for example, are not larger than 1/10 so that the output Y1′ of the adder-subtractor 86 is slightly different from the output Y1 of the adder 36.

The DUR improving unit 37 generates the signal Y1′ in which the contribution degree of the second wave is reduced from the output Y1 of the adder 36.

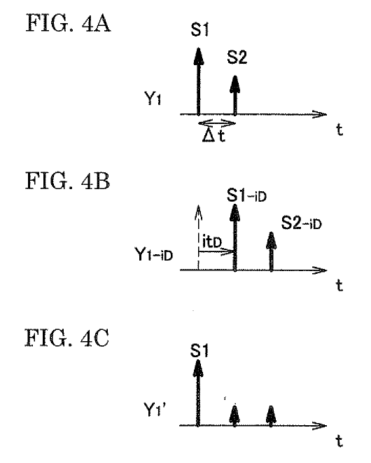

In FIGS. 4A to 4C, S1 denotes the arrived first wave, S2 denotes the arrived second wave, the horizontal axis shows an arrived time of the head of these signals and the vertical axis shows the intensity of these signals.

As shown in FIG. 4A, the output Y1 of the adder 36 is defined as the sum of the first wave S1 and the second wave S2. The difference of arrived times of the heads of the signals of the first wave S1 and the second wave S2, i.e., a delay time of the second wave S2 is defined as Δt.

As shown in FIG. 4B, the delayed signals Y1-iD as much as a sum delay time itD of the output Y1 of the adder 36 (where i is a natural number not larger than 5 in FIG. 3 and FIGS. 4A to 4C) becomes the sum of S1-iD which the first wave S1 is delayed as much as the sum delay time itD and S2-1D which the second wave S2 is delayed as much as the sum delay time itD.

Now, if the delay time Δt of the second wave S2 of FIG. 4A accords with the delay time itD of the second wave S2 of FIG. 4B, an obtained signal Y1′ after multiplying signal Y1-iD appeared in FIG. 4B by a proper coefficient, and subtract multiplied result from the signal Y1 appeared in FIG. 4A may be the sum of the first wave S1 and the suppressed second wave S2 and the sum of S2-1D which is not so big (FIG. 4C).

At this time, because the signal Y1′ includes undesirable delay wave S2-iD, the signal Y1′ may not be pertinent as the signal for separating subcarriers. However, since the signal Y1′ includes the first wave S1 which has the same intensity of the output Y1 of the adder 36 and is not delayed and the second wave S2 is being suppressed, the complex weights can be adaptively calculated based on the signal Y1′ with no problem. In addition, for example, in the case of including the first wave S1 and the second wave S2 having the same intensity to the combined signal Y1, if the complex weights are calculated so as to generate the combined signal Y1 based on the suppressed signal Y1′ of the second wave S2 which is the delay wave, the feedback to increase the contribution degree of the first wave can be made.

Also, when the sum delay time itD of FIG. 4B does not accord the delay time Δt of FIG. 4A, because the DUR improving unit 37 of FIG. 3 is comprised of multi-step delay circuits, for example, if a condition is itD<Δt<(i+1)tD, it can calculate the complex weights after suppressing the second wave S2 similarly by the signal Y1-iD which the sum delay time becomes itD and the signal Y1-(i+1)D which the sum delay time becomes (i+1)tD.

As understood from the above discussion, the absolute value of the complex weights WiD multiplied by signals Y1-iD of which the sum delay time becomes itD (i is a natural number not larger than 5 in FIG. 3 and FIG. 4) of FIG. 3 needs to be small always. For example, the absolute value of the complex weights WiD does not exceed 1, for example, may be below 1/10. The necessary condition in the signal Y1′ is not to put down the contribution degree of the first wave S1, but to slightly put down the contribution degree of the delay wave after the second wave. It does not need to wholly eliminate the delay wave after the second wave.

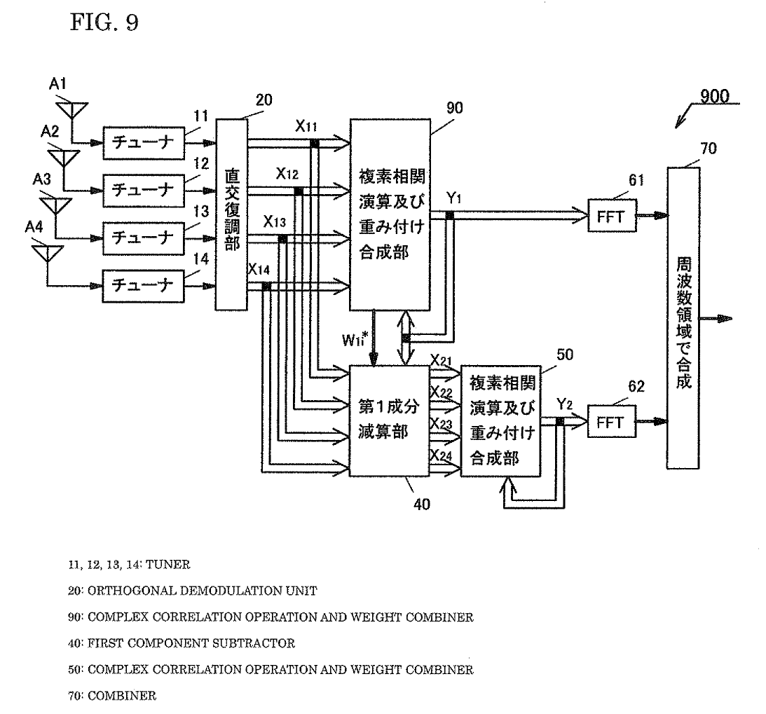

In order to compare the operation of the diversity receiver 100 of the configuration shown in FIG. 1, FIG. 2 and FIG. 3 with the operation of the related-art diversity receiver 900 of the configuration shown in FIG. 9 and FIG. 10, a simulation have performed.

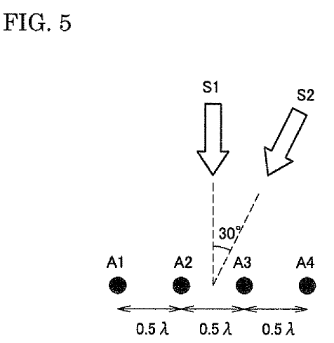

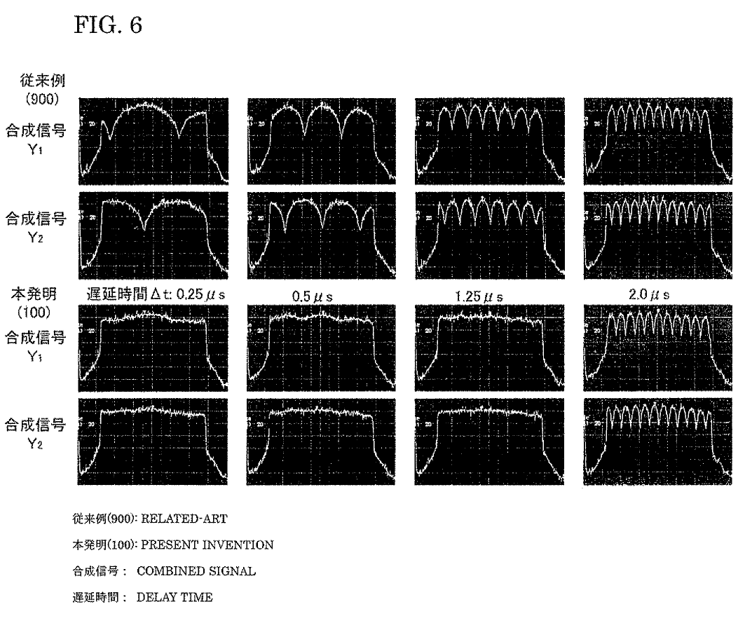

As shown in FIG. 5, four antennas A1, A2, A3 and A4 are arranged in this order on a line at an interval of a half wavelength of a carrier. Also, the desired wave (the first wave) S1 is arrived from the direction of a perpendicular bisector of a line connected to the antennas A2 and A3. The delay wave (the second wave) S2 is set up to arrive at an angle of 30 degrees therefrom, and to arrive with the completely same intensity as the desired wave (the first wave) S1 from an inclined direction toward antenna A3. At that time, the antennas are fixed, and are assumed to receive the terrestrial digital broadcasting of the OFDM method. In the case of the condition of which each delay time tD of five delay circuits (memories) 801, 802, 803, 804, and 805 of FIG. 3 is set to 0.25 μs, and the condition of which delay time Δt of the delay wave (the second wave) S2 is set to 0.25 μs, 0.5 μs, 1.25 μs, and 2.0 μs. Input signal waveforms of the Fast Fourier Transform processors 61 and 62 are analyzed as shown in FIG. 6.

FIG. 6 shows the input signal waveform of the Fast Fourier Transform processors 61 and 62 of related-art diversity receiver 900 as shown in FIG. 9 and FIG. 10, and the input signal waveform of the Fast Fourier Transform processors 61 and 62 of the diversity receiver 100 according to the example of the present invention are shown in FIG. 1, FIG. 2 and FIG. 3.

The input signal waveform of the Fast Fourier Transform processors 61 and 62 of the diversity receiver 100, became flat when the delay time Δt of the delay wave (the second wave) S2 is set to 0.25 μs, 0.5 μs, 1.25 μs, and 2.0 μs, to thereby recognize that the signals are respectively input to the Fast Fourier Transform processors 61 and 62 by separating the first wave and the second wave. Also, when the delay time Δt is 2.0 μs, because maximum delay time 5tD=1.25 μs of five steps delay circuit in FIG. 3. is exceeded, it can be recognized that the signals are input to the Fast Fourier Transform processors 61 and 62 while the first wave and the second wave are not separated.

On the other hand, in conventional diversity receiver 900 of the configuration in FIG. 9 and FIG. 10, even when the delay time Δt is any case of 0.25 μs, 0.5 μs, 1.25 μs, and 2.0 μs, it can be recognized that the signals are input to the Fast Fourier Transform processors 61 and 62 while the first wave and the second wave are not separated.

As described above, if a received wave is the delay wave within a maximum delay time in the DUR improving unit 37, the diversity receiver 100 may generate two combined signals Y1 and Y2 in which the desired wave and the delay wave are separated even in the case of having no intensity difference with the desired wave.

### EXAMPLE 2

A simulation to receive the terrestrial digital broadcasting of OFDM method in a traveling vehicle is performed.

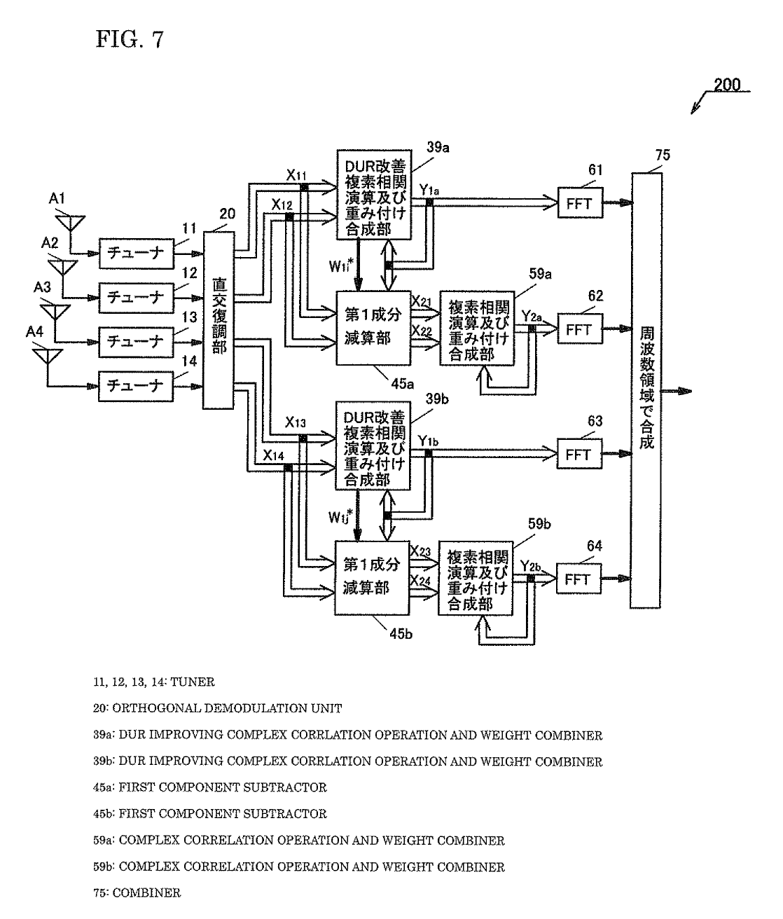

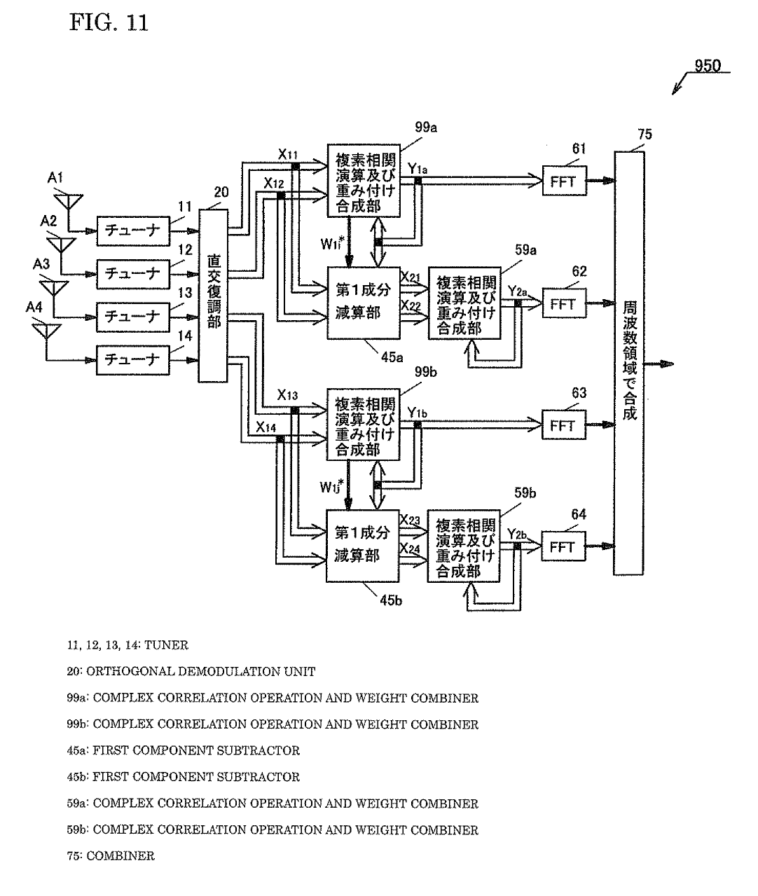

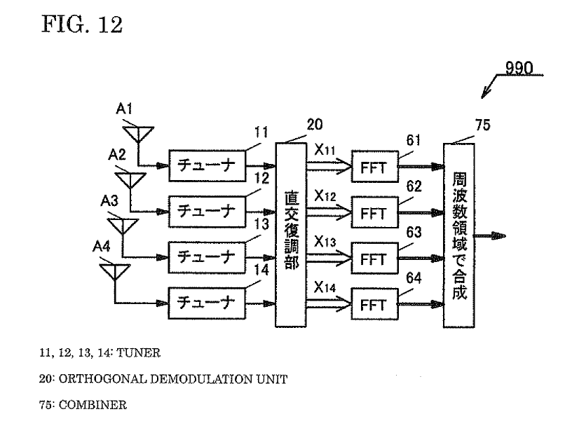

At that time, in compare with the diversity receiver 100 of the configuration in FIG. 1, FIG. 2 and FIG. 3, it has laid the diversity receiver 200 in FIG. 7 and the diversity receiver 950 in FIG. 11, and the diversity receiver 990 in FIG. 12 except for the diversity receiver 900 in FIG. 9 and FIG. 10.

The diversity receiver 200 in FIG. 7 based on the diversity receiver 100 in FIG. 1, includes the configuration that combines the complex signals which are separated into the first wave S1 and the second wave S2 by the complex baseband signals X1 and X12 based on the received wave of the antenna A1 and A2 after making two pairs of antennas and the complex signals which are separated into the first wave S1 and the second wave S2 by the complex baseband signals X13 and X14 based on the received wave of the antennas A3 and A4. The complex signals in total of four frequency regions are combined per each subcarrier in the combiner 75.

That is, the diversity receiver 200 obtains the combined signal Y1a and the combined signal Y2a by the DUR improving complex correlation operation and weight combiner 39a, the first component subtractor 45a, and the complex correlation operation and weight combiner 59a for the complex baseband signals X1 and X12 based on the received wave of antennas Al and A2, and inputs obtained signals to the Fast Fourier Transform processors 61 and 62 respectively. The diversity receiver 200 obtains the combined signal Y1b and the combined signal Y2b by the DUR improving complex correlation operation and weight combiner 39b, the first component subtractor 45b, and the complex correlation operation and weight combiner 59b for the complex baseband signal X13 and X14 based on the received wave of antennas A3 and A4, and inputs obtained signals to the Fast Fourier Transform processors 63 and 64 respectively.

The diversity receiver 200 in FIG. 7 can be said to implement the path diversity about four other propagation channels.

The DUR improving complex correlation operation and weight combiners 39a and 39b of FIG. 7, include two complex multipliers in the complex correlation operation and weight combiners 30 in FIG. 3, and calculates two complex weights by the weight coefficient operating unit.

The first component subtractors 45a and 45b in FIG. 7, include two complex adders/subtractors in the first component subtractor 40 in FIG. 3.

The complex correlation operation and weight combiners 59a and 59b in FIG. 7, include two complex multipliers in the complex correlation operation and weight combiner 50 in FIG. 3, and calculates two complex weights of the weight coefficient operating unit.

The diversity receiver 950 in FIG. 11, based on the related-art diversity receiver 900 in FIG. 9, includes the configuration that combines the complex signals which are separated into the first wave and the second wave by the complex baseband signals X11 and X12 based on the received wave of the antenna A1 and A2 after making two pairs of antennas and the complex signals which are separated into the first wave and the second wave by the complex baseband signals X13 and X14 based on the received wave of the antennas A3 and A4. The complex signals in total of four frequency regions are combined per each subcarrier in the combiner 75.

The diversity receiver 950 in FIG. 11 can be said to implement the path diversity for four other propagation channels.

The configuration of the diversity receiver 950 in FIG. 11 replaces the DUR improving complex correlation operation and weight combiners 39a and 39b of the diversity receiver 200 in FIG. 7 with the complex correlation operation and weight combiners 99a and 99b. The complex correlation operation and weight combiner 99a and 99b of the diversity receiver 950 in FIG. 11 has the same configuration that the complex correlation operation and weight combiner 59a and 59b of the diversity receiver 200 in FIG. 7 and the diversity receiver 950 in FIG. 11.

The diversity receiver 990 in FIG. 12 does not implement the adaptive array technology, but implements only the diversity after separating subcarriers.

That is, the diversity receiver 990 in FIG. 12 comprises four antennas A1, A2, A3 and A4, four tuners 11, 12, 13, and 14, an orthogonal demodulation unit 20, four Fast Fourier Transform processors 61, 62, 63 and 64, and the combiner 75. The diversity receiver 990 in FIG. 12 can be said to implement the path diversity for four other propagation channels by directly converting the Fast Fourier Transform complex baseband signals X11, X12, X13 and X14 based on the received wave of antennas A1, A2, A3 and A4 and separating subcarriers.

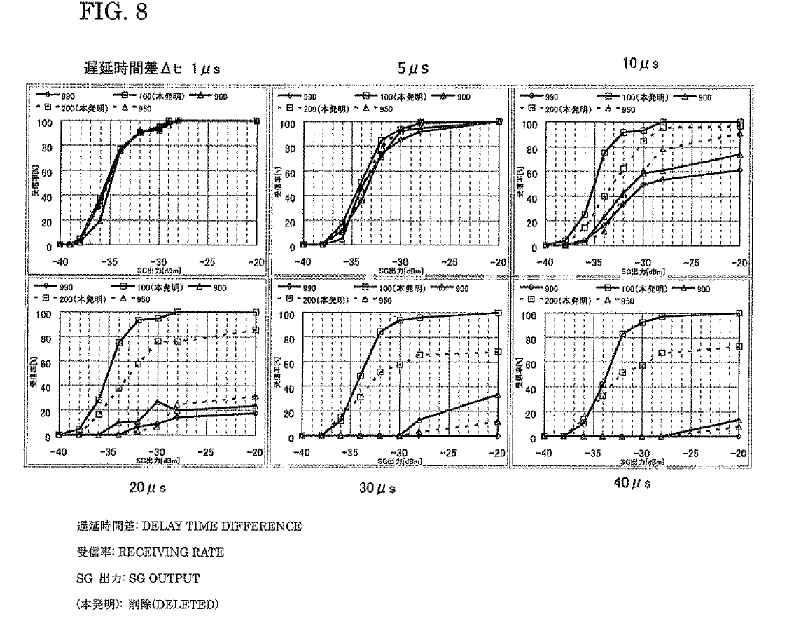

A simulation of reception of terrestrial wave television broadcasting at a paging speed of 5 km/h was performed with respect to five diversity receiver including the diversity receiver 100 of the configuration in FIG. 1, FIG. 2 and FIG. 3, the diversity receiver 200 in FIG. 7, the diversity receiver 900 of the configuration in FIG. 9 and FIG. 10, the diversity receiver 950 in FIG. 11, and the diversity receiver 990 of the configuration of FIG. 12. The result is shown in FIG. 8. In FIG. 8, it is determined whether each one frame of the television image can be received or not. FIG. 8 shows the receiving rate % which is a receivable frame rate.

Also, the antennas have the same arrangement as shown in FIG. 5. Since a delay time Δt for the first wave S1 of the second wave S2 set up 1 μs, 5 μs, 10 μs, 20 μs, 30 μs and 40 μs, the receiving rate was calculated by changing a mean receiving intensity (SG output in FIG. 8) of the first wave S1 and the second wave S2 into −40 to −20 dBm.

Also, in order to simplify the simulation with respect to the diversity receiver 100 of the configuration in FIG. 1, FIG. 2, and FIG. 3, and the diversity receiver 200 in FIG. 7, in the DUR improving unit 37, the simulation was performed since a sum delay time of the output of the delay circuit at a predetermined stage set up to accord the delay time Δt for the first wave S1 of the second wave S2.

As shown in FIG. 8, at the delay time of 1 μs, the receiving rate of the diversity receivers 100 and 200, the related-art diversity receiver 900 and the diversity receivers 950, and 990 according to comparative examples had almost no difference in a receiving intensity range. Also, when all the receiving intensity was more than −30 dBm, the receiving rate exceeded 90% and when the receiving intensity was more than −28 dBm, the receiving rate came up to 100%.

At the delay time of 5 μs, the receiving rate of the diversity receiver 990 related to the comparative example was lower, but the difference in five devices was a little.

At the delay time of 10 μs, the receiving rate of the diversity receiver 900, 950 and 990 related to the comparative example was much lower. At the receiving intensity of −28 dBm, the receiving rate of the diversity receiver 100 and 200 related to the present invention were 100% and 96%, which are satisfactory sufficiently to use as the television receiver. On the other hand, the receiving rate of the diversity receiver 900, 950 and 990 related to the comparative example were 61%, 78% and 53% respectively which are not enough to use as the television receiver.

At the delay time of 20 μs, the receiving intensity was −28 dBm, the receiving rates of the diversity receiver 100 and 200 related to the present invention was 100% and 87%. The receiving rates of the diversity receiver 900, 950 and 990 related to the comparative example were below 40% within the range in the receiving intensity of at −40 to −20 dBm, and became impertinent to use as the television receiver.

At the delay time of 30 μs and 40 μs, the receiving rate of the diversity receiver 100 related to the present invention exceeded 90% in the case that the receiving intensity was more than −30 dBm, particularly came up to 100% in −20 dBm, was satisfactory sufficiently to use as the television receiver.

When the receiving intensity was equal to or more than −30 dBm, the receiving rate of the diversity receiver 200 related to the present invention exceeded 60%, it is confirmed that a little unsatisfactory but a constant effect may be obtained.

The receiving rate of the diversity receiver 900 related to the comparative example was below 40% within the range in the receiving intensity of −40 to −20 dBm, and became impertinent to use as the television receiver. In the same manner, the receiving rate of the diversity receiver 950 and 990 related to the comparative example was below 10% within the range in the receiving intensity of −40 to −20 dBm, and may not be used entirely as the television receiver.

### MODIFIED EXAMPLE 1

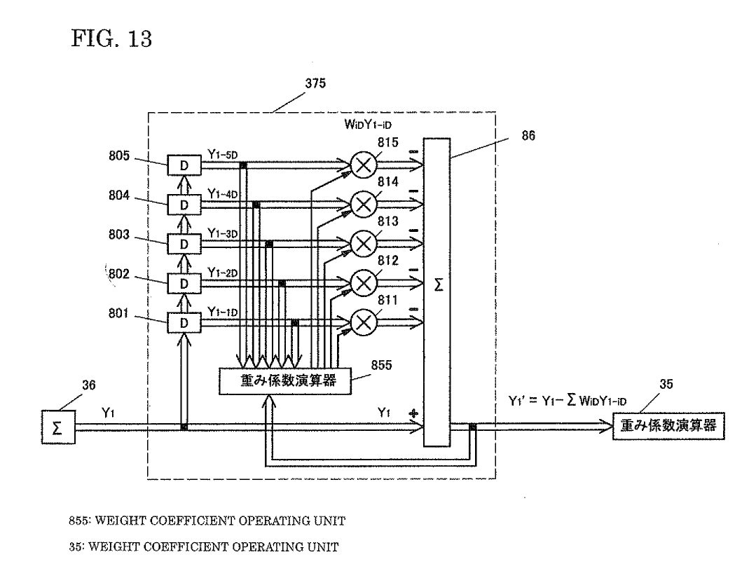

Among the configuration of the diversity receiver 100 of FIG. 1 and FIG. 2 shown in the Example 1, after switching into the DUR improving unit 37 shown in FIG. 3, even though a modified example consists of using the DUR improving unit 375 as shown in FIG. 13, almost the same effect as Example 1 can be obtained.

In the DUR improving unit 37 in FIG. 3, the weight coefficient operating unit 85 determines the five complex weights W1D, W2D, W3D, W4D, and W5D by the complex correlation between the combined signal Y1 which is the output of the adder 36 and each of the delay signals Y-1D, Y1-2D, Y1-3D, Y1-4D and Y1-5D.

On the other hand, in the DUR improving unit 375 according to the modified example shown in FIG. 13, the weight coefficient operating unit 855 determines the five complex weights W1D, W2D, W3D, W4D, and W5D by the complex correlation between the combined signal Y1′ which is the output of the adder 86, and each of the delay signals Y1-1D, Y1-2D, Y1-3D, Y1-4D and Y1-5D.

In accordance with this structure, the feedback to increase the contribution degree of the first wave can be performed quickly.

### MODIFIED EXAMPLE 2

In the Example 1, the diversity receiver 100 having the configuration shown in FIG. 1, FIG. 2 and FIG. 3, includes two adaptive arrays to perform the path diversity after separating subcarriers. To eliminate the second wave, the first component subtractor 40 and the complex correlation operation and weight combiner 50 (the second combiner), the Fast Fourier Transform processor 62 and the combiner 70 can be omitted.

Likewise, the diversity receiver 200 having the configuration shown in FIG. 7 includes two adaptive arrays for two groups of the antennas. However, To eliminate the second wave, the first component subtractors 45a and 45b and the complex correlation operation and weight combiners 59a and 59b, the Fast Fourier Transform processors 62 and 64 can be omitted, and the combiner 75 can be replaced with the combiner 70.

The present invention can be effectively applied to a terrestrial wave digital broadcasting receiver mounted on a vehicle.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A diversity receiver, comprising:
a first adaptive array unit that obtains a first combined signal by combining received signals of a plurality of antennas with using first complex weights; and
a second adaptive array unit that obtains a second combined signal by combining the received signals of the antennas with using second complex weights,
wherein the first adaptive array unit includes a first combiner that obtains the first combined signal comprised mainly of a first wave of the received signals,
wherein the second adaptive array unit includes a first component subtractor that subtract the first combined signal from the respective received signals and a second combiner that obtains the second combined signal comprised mainly of a second wave of the received signals based on outputs of the first component subtractor,
wherein the first combiner includes a delay wave suppressing unit that generates a suppressed signal in which components of the second wave is suppressed from the first combined signal and a first weight coefficient operating unit that determines the first complex weights by complex correlation operation between outputs of the delay wave suppressing unit and the received signals, and
wherein the second combiner includes a second weight coefficient operating unit that determines the second complex weights by complex correlation operation between the second combined signal and the outputs of the first component subtractor.

2. The diversity receiver as set forth in claim 1, wherein the delay wave suppressing unit includes:
a plurality of delay circuits which are connected in serial, the delay circuits to which the first combined signal is input;
a third weight coefficient operating unit that determines third complex weight by complex correlation operation between each of outputs of the delay circuits and the first combined signal;
a plurality of multipliers that multiplies the outputs of the delay circuits by the third weight coefficient, respectively; and
an adder-subtractor that subtracts outputs of the multipliers from the first combined signal to generate the suppressed signal.

3. The diversity receiver as set forth in claim 1,
wherein the antennas are divided into a plurality of groups, and
wherein the first and second adaptive array units obtain the first and second combined signals in at least one of the groups.

4. The diversity receivers as set forth in claim 1,
wherein the received signals are multi-carrier modulated signals, and
wherein the first combined signal and the second combined signal are separated into subcarriers and then subjected to path diversity.

5. The diversity receivers as set forth in claim 1, wherein the received signals are Orthogonal Frequency-Division Multiplexing signals.

6. A diversity receiver, comprising:
an adaptive array unit that obtains a combined signal comprised mainly of a first wave of received signals of a plurality of antennas by combining the received signals with using first complex weights,
wherein the adaptive array unit includes a delay wave suppressing unit that generates a suppressed signal in which components of a second wave of the received signals is suppressed from the combined signal and a first weight coefficient operating unit that determines the first complex weights by complex correlation operation between outputs of the delay wave suppressing unit and the received signals.

7. The diversity receiver as set forth in claim 5, wherein the delay wave suppressing unit includes:
a plurality of delay circuits which are connected in serial, the delay circuits to which the combined signal is input;
a second weight coefficient operating unit that determines second complex weight by complex correlation operation between each of outputs of the delay circuits and the combined signal;
a plurality of multipliers that multiplies the outputs of the delay circuits by the second weight coefficient, respectively; and
an adder-subtractor that subtracts outputs of the multipliers from the combined signal to generate the suppressed signal.

8. The diversity receiver as set forth in claim 6, wherein the received signals are Orthogonal Frequency-Division Multiplexing signals.
